(19) United States
(12) Patent Application Publication
(10) Pub. No.: US 2025/0334868 A1
(43) Pub. Date: Oct. 30, 2025

(54) VAPOR CHAMBER, COOLING DEVICE, ELECTRONIC DEVICE, WAVELENGTH CONVERSION DEVICE, AND PROJECTOR

(71) Applicant: SEIKO EPSON CORPORATION, Tokyo (JP)

(72) Inventors: Naoya SHINDO, AZUMINO-SHI (JP); Masato KADOTANI, MATSUMOTO-SHI (JP)

(21) Appl. No.: 19/188,537

(22) Filed: Apr. 24, 2025

(30) Foreign Application Priority Data
Apr. 24, 2024 (JP) 2024-070937

(51) Int. Cl. G03B 21/16; G03B 21/20

(52) U.S. Cl. CPC G03B 21/16; G03B 21/204

(57) ABSTRACT

The vapor chamber includes a first substrate that has thermal conductivity; a second substrate opposed to the first substrate and having thermal conductivity; an accommodation chamber having an accommodation space formed by bonding a peripheral section of the first substrate and a peripheral section of the second substrate; the working medium accommodated in the accommodation chamber and transitioning between gas and liquid phases due to heat; and

a plurality of pillars arranged between an inner surface of the first substrate and an inner surface of the second substrate in the accommodation chamber, wherein the first substrate has a placement region located on an outer surface of the first substrate and in which a heat-generating body is arranged, a corresponding region located on the inner surface of the first substrate and corresponding to the placement region, the plurality of pillars has at least one inner pillar arranged in the corresponding region, a plurality of outer pillars arranged outside the corresponding region, and the number of inner pillars per unit area in the corresponding region is larger than the number of pillars per unit area in the entire accommodation chamber.

The present application is based on, and claims priority from JP Application Serial Number 2024-070937, filed Apr. 24, 2024, the disclosure of which is hereby incorporated by reference herein in its entirety.

### BACKGROUND

### 1. Technical Field

The present disclosure relates to a vapor chamber, a cooling device, an electronic device, a wavelength conversion device, and a projector.

### 2. Related Art

For example, a cooling mechanism for cooling a light source unit including a plurality of light emitting elements that emit light as described in JP-A-2019-128465 is known.

The cooling mechanism described in JP-A-2019-128465 includes a heat receiver plate, a heat diffusion member, a heat radiation fin, and a cooling fan. The light source unit is fixed to the heat receiver plate. The heat diffusion member is a vapor chamber. The heat diffusion member is inserted into the opening section of the heat receiver plate and has a protruding portion that comes into contact with a base member that holds the plurality of light emitting elements in the light source unit. The heat radiation fin is fixed to the heat diffusion member, and an airflow is circulated through the plurality of fins of the heat radiation fin by the cooling fan.

On the other hand, as the vapor chamber described in JP-A-2022-63805, a vapor chamber in which a plurality of pillar sections are provided is known.

The vapor chamber described in JP-A-2022-63805 includes a housing including an internal space formed by a first metal plate and a second metal plate that are bonded to each other so as to face each other. In the internal space, a wick structure and a working medium are housed, and a plurality of pillar sections are arranged. The plurality of pillar sections protrude from the second metal plate toward the first metal plate. The plurality of pillar sections are in contact with the wick structure or in contact with the first metal plate via a through hole provided in the wick structure to support the first metal plate. In the vapor chamber described in JP-A-2022-63805, when an external force acts on the outer surface of the housing, the plurality of pillar sections suppress the deformation of the housing and prevent the narrowing of the internal space.

In the cooling mechanism described in JP-A-2019-128465, the heat diffusion member is in contact with a base member of a light source unit, which is a heat source, at the protruding portion. Therefore, the efficiency of heat transfer from the base member to the heat diffusion member is low. On the other hand, it is considered that the heat source and the vapor chamber are bonded to each other and the heat from the heat source is efficiently transmitted to the vapor chamber.

However, due to a high temperature when the heat source is bonded to the vapor chamber, the internal pressure of the vapor chamber increases, and an expansion force acts on the vapor chamber. On the other hand, as in a vapor chamber described in JP-A-2022-63805, a plurality of pillar sections may be provided inside the vapor chamber.

However, there is a problem in that the expansion force easily exceeds the bonding limit of the plurality of pillar sections between the first substrate and the second substrate in a portion where the temperature locally increases, such as a portion where the heat source is bonded, and the vapor chamber easily expands.

On the other hand, it is conceivable to increase the pressure resistance of the vapor chamber by increasing the number of pillar sections. However, if the number of pillar sections to be installed is increased as a whole, the internal space is narrowed, and the working medium is less likely to flow, which causes a problem of a decrease in the cooling performance of the vapor chamber.

For these reasons, a configuration of a vapor chamber capable of improving pressure resistance and cooling performance has been desired.

### SUMMARY

The vapor chamber according to the first aspect of the present disclosure includes
a first substrate that has thermal conductivity;
a second substrate that faces the first substrate and that has thermal conductivity;
an accommodation chamber including an accommodation space configured by bonding together a peripheral section of the first substrate and a peripheral section of the second substrate;
a working medium that is accommodated in the accommodation chamber and that transitions between a gas phase and a liquid phase by heat; and
a plurality of pillars between inner surfaces of the first and second substrates within the accommodation chamber, wherein
the first substrate includes
   a placement region that is located on an outer surface of the first substrate and on which a heat-generating body is arranged and
   a corresponding region that is located on an inner surface of the first substrate and that corresponds to the placement region,
the pillars include
   at least one inner pillar arranged in the corresponding region and
   a plurality of outer pillars arranged outside the corresponding region, and
the number of inner pillars per unit area in the corresponding region is larger than the number of pillars per unit area in the entire accommodation chamber.

The cooling device according to the second aspect of the present disclosure includes
the vapor chamber according to the first aspect and the heat-generating body bonded to the placement region.

The electronic device according to the third aspect of the present disclosure includes
the cooling device according to the second aspect.

The wavelength conversion device according to the fourth aspect of the present disclosure includes
the cooling device according to the second aspect wherein
the heat-generating body is a fluorescent substance that converts the wavelength of incident light and emits fluorescent light and the fluorescent substance is bonded to the placement region using a heat conductive bonding material.

A projector according to a fifth aspect of the present disclosure includes
a light source;
the wavelength conversion device, according to the fourth aspect, where light incident from the light source acts as excitation light;
an image forming device that creates image light from light including the fluorescent light emitted by the fluorescent substance; and a projection optical device that projects the image light.

### BRIEF DESCRIPTION OF THE DRAWINGS

FIG. 1 is a schematic view showing configuration of a projector according to a first embodiment.

FIG. 2 is a schematic view showing configuration of a light source device in the first embodiment.

FIG. 3 is a perspective view showing the wavelength conversion device in the first embodiment.

FIG. 4 is an exploded perspective view showing the wavelength conversion device according to the first embodiment.

FIG. 5 is a view showing an internal structure of the vapor chamber according to the first embodiment.

FIG. 6 is a view showing the vapor chamber with the second substrate removed according to the first embodiment.

FIG. 7 is a cross-sectional view showing a first modification of the vapor chamber according to the first embodiment.

FIG. 8 is a cross-sectional view showing a second modification of the vapor chamber according to the first embodiment.

FIG. 9 is a view showing the internal structure of the vapor chamber of the wavelength conversion device included in the projector according to the second embodiment.

FIG. 10 is a cross-sectional view showing a vapor chamber of a wavelength conversion device included in the projector according to the third embodiment.

### DESCRIPTION OF EMBODIMENTS

### First Embodiment

Hereinafter, a first embodiment of the present disclosure will be described with reference to the drawings.

### Schematic Configuration of the Projector

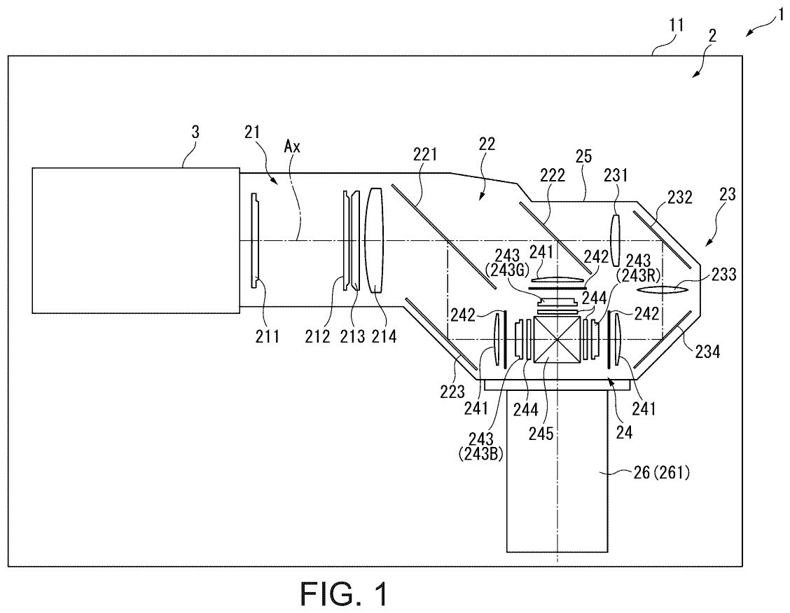

FIG. 1 is a schematic view showing configuration of a projector 1 according to a present embodiment.

The projector 1 according to the present embodiment is an electronic device that projects image light corresponding to image information. As shown in FIG. 1, the projector 1 includes an exterior housing 11 and an image projection device 2 housed in the exterior housing 11. In addition, although not shown, the projector 1 includes a control device that controls the operation of the projector 1 and a power supply device that supplies electric power to the electronic components of the projector 1.

### Configuration of the Image Projection Device

The image projection device 2 projects image light corresponding to the input image information. The image projection device 2 includes a light source device 3, a homogenization optics system 21, a color separation optics system 22, a relay optics system 23, an image forming device 24, an optical enclosure 25, and a projection optical device 26.

The light source device 3 emits illumination light to the homogenization optics system 21. The configuration of light source device 3 will be described in detail later.

The homogenization optics system 21 homogenizes the illumination light emitted from the light source device 3. The homogenized illumination light passes through the color separation optics system 22 and the relay optics system 23, and illuminates a modulation region of an optical modulation element 243 (to be described later). The homogenization optics system 21 includes lens arrays 211 and 212, a polarization conversion element 213, and a superimposing lens 214.

The color separation optics system 22 separates the illumination light incident from the homogenization optics system 21 into red, green, and blue light. The color separation optics system 22 includes dichroic mirrors 221 and 222 and a reflective mirror 223 that reflects the blue light separated by the dichroic mirror 221.

The relay optics system 23 is provided in the optical path of the red light, which is longer than the optical paths of the other color lights, and suppresses the loss of the red light. The relay optics system 23 includes an incident side lens 231, a relay lens 233, and reflective mirrors 232 and 234. In the present embodiment, the red light is guided to the relay optics system 23. However, the present disclosure is not limited to this, and for example, color light having a longer optical path than the other color light may be blue light, and the blue light may be guided to the relay optics system 23.

The image forming device 24 modulates red, green, and blue color light beams emitted from the light source device 3 and separated from each other, and combines the modulated color light beams to form image light. That is, the image forming device 24 forms the image light from the light including the fluorescent light emitted from a fluorescent substance 41 of a wavelength conversion device 4A constituting the light source device 3. The image forming device 24 includes three field lenses 241, three incident side polarizing plates 242, three optical modulation elements 243, three exit side polarizing plates 244, and one color combining optical system 245, which are provided in accordance with the incident color light.

The optical modulation element 243 modulates light from the light source device 3 to form image light. Specifically, the optical modulation element 243 modulates the color light incident from the incident side polarizing plate 242 according to the image signal, and emits the modulated color light. The three optical modulation elements 243 include an optical modulation element 243R for modulating red color light, an optical modulation element 243G for modulating green color light, and an optical modulation element 243B for modulating blue color light. As the optical modulation element 243, a transmissive liquid crystal panel can be exemplified.

The color combining optical system 245 combines the three colored lights modulated by the optical modulation elements 243R, 243G, and 243B and incident from the respective exit side polarizing plates 244. The image light combined by the color combining optical system 245 is incident on the projection optical device 26. In the present embodiment, the color combining optical system 245 is constituted by a substantially rectangular parallelepiped cross dichroic prism, but it may be constituted by a plurality of dichroic mirrors.

The optical enclosure 25 accommodates the homogenization optics system 21, the color separation optics system 22, the relay optics system 23, and the image forming device 24 therein. In the image projection device 2, an optical axis Ax is set by design, and the optical enclosure 25 holds the homogenization optics system 21, the color separation optics system 22, the relay optics system 23, and the image forming device 24 at predetermined positions on the optical axis Ax. The light source device 3 and the projection optical device 26 are arranged at predetermined positions on the optical axis Ax.

The projection optical device 26 projects image light incident from the image forming device 24 onto a projected surface such as a screen. That is, the projection optical device 26 projects the image light formed by the image forming device 24. The projection optical device 26 may be, for example, a lens assembly including a plurality of lenses (not shown) and a lens barrel 261 that houses the plurality of lenses.

### Configuration of the Light Source Device

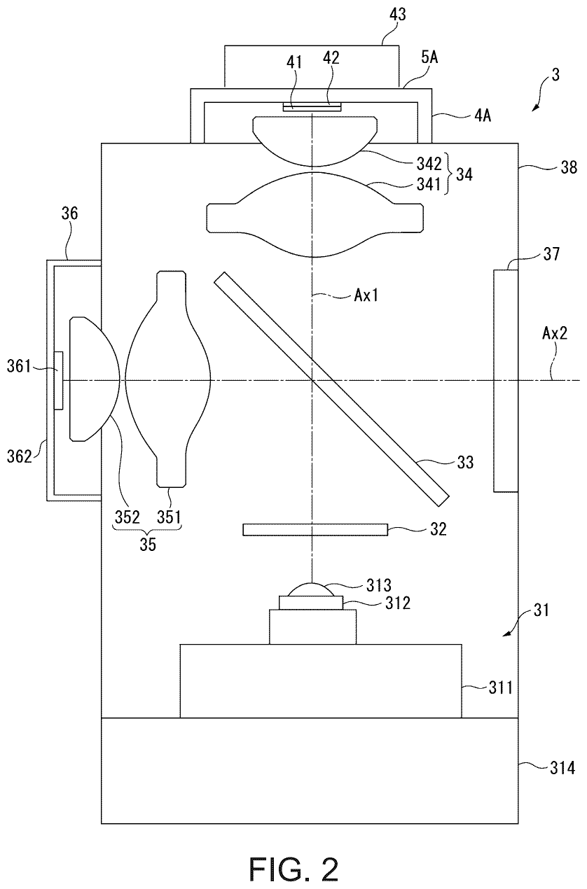

FIG. 2 is a schematic view showing the configuration of the light source device 3.

The light source device 3 emits illumination light for illuminating the modulation region of each optical modulation element 243 to the homogenization optics system 21. As shown in FIG. 2, the light source device 3 includes a light source 31, a diffuse transmission section 32, an optical separation section 33, a first optical condensing element 34, the wavelength conversion device 4A, a second optical condensing element 35, a diffuse reflection element 36, a phase difference section 37, and a support member 38 that supports these components.

In the light source device 3, the illumination optical axes Ax1 and Ax2 are set to intersect each other.

The light source 31, the diffuse transmission section 32, the optical separation section 33, the first optical condensing element 34, and the wavelength conversion device 4A are arranged on the illumination optical axis Ax1.

The optical separation section 33, the second optical condensing element 35, the diffuse reflection element 36, and the phase difference section 37 are arranged on the illumination optical axis Ax2. The optical separation section 33 is arranged at the intersection of the illumination optical axis Ax1 and the illumination optical axis Ax2.

The illumination optical axis Ax2 coincides with the optical axis Ax at the position of the lens array 211. In other words, the illumination optical axis Ax2 is set on an extension line of the optical axis Ax.

The light source 31 includes a substrate 311, a light emitting element 312, a collimator lens 313, and a heat radiation member 314.

The substrate 311 supports the light emitting element 312 and the collimator lens 313.

The light emitting element 312 emits light. Although not shown, the light emitting element 312 is composed of a plurality of semiconductor lasers that emit blue light. The light emitting element 312 and the substrate 311 are one of the heat-generating bodies that generate heat when the light source 31 is turned on.

The collimator lens 313 collimates the light emitted from the light emitting element 312.

The heat radiation member 314 is coupled in a heat transferable manner to a surface of the substrate 311 on the opposite side than the surface on which the light emitting element 312 and the collimator lens 313 are arranged. The heat radiation member 314 is cooled by a cooling gas sent from a fan (not shown), and thus the light source 31 is cooled.

The diffuse transmission section 32 diffuses the light incident from the light source 31 and homogenizes the illuminance distribution of the emitted light. Examples of the diffuse transmission section 32 include a configuration having a hologram, a configuration in which a plurality of small lenses are arranged on a plane orthogonal to the optical axis, and a configuration in which a surface through which light passes is a rough surface.

Instead of the diffuse transmission section 32, a homogenizer optical element with a pair of multi-lens arrays may be used in the light source device 3. On the other hand, in the case where the diffuse transmission section 32 is adopted, the distance from the light source 31 to the optical separation section 33 can be shortened as compared with the case where a homogenizer optical element is adopted. The light emitted from the diffuse transmission section 32 is incident on the optical separation section 33.

The optical separation section 33 has a function of a half mirror that transmits a part of the light incident via the diffuse transmission section 32 from the light source 31 and reflects the other light. The optical separation section 33 has a function of a dichroic mirror that transmits the blue light incident from the diffuse reflection element 36 and reflects light that is incident from the wavelength conversion device 4A and that has a wavelength longer than that of the blue light.

In detail, the optical separation section 33 transmits a first partial light, which is a part of the blue light incident from the diffuse transmission section 32, so as to be incident on the first optical condensing element 34, and reflects a second partial light, which is the remaining blue light, so as to be incident on the second optical condensing element 35.

In the present embodiment, in consideration of light absorption in the wavelength conversion device 4A, the optical separation section 33 increases the light amount of the first partial light to be larger than the light amount of the second partial light. However, the present disclosure is not limited to this, and the light amount of the first partial light may be the same as the light amount of the second partial light, or may be smaller than the light amount of the second partial light.

The first optical condensing element 34 condenses the first partial light that passed through the optical separation section 33 at the wavelength conversion device 4A. The first optical condensing element 34 collimates the light incident from the wavelength conversion device 4A.

In the present embodiment, the first optical condensing element 34 includes two lenses 341 and 342, but the number of lenses constituting the first optical condensing element 34 is not limited to two.

The wavelength conversion device 4A diffuses and emits the light that was obtained by converting the wavelength of the incident light, in a direction opposite to the direction of the light incident on the wavelength conversion device 4A. Specifically, the wavelength conversion device 4A is excited by the blue light as the exciting light incident thereon, and diffuses and emits fluorescent light having wavelengths longer than the wavelengths of the incident blue light toward the first optical condensing element 34. That is, the wavelength conversion device 4A converts light having a first waveband emitted from the light source 31 into light having a second waveband different from the first waveband. The light emitted from the wavelength conversion device 4A is, for example, fluorescent light with peak wavelengths around 500 to 700 nm.

The fluorescent light emitted from the wavelength conversion device 4A passes through the first optical condensing element 34 along the illumination optical axis Ax1, and then is incident on the optical separation section 33. The fluorescence light incident on the optical separation section 33 is reflected in the direction along the illumination optical axis Ax2 by the optical separation section 33 and is incident on the phase difference section 37.

The configuration of the wavelength conversion device 4A will be described in detail later.

The second optical condensing element 35 condenses the second partial light reflected by the optical separation section 33 and incident on the diffuse reflection element 36. The second optical condensing element 35 collimates the blue light incident from the diffuse reflection element 36.

In the present embodiment, the second optical condensing element 35 includes two lenses 351 and 352, similarly to the first optical condensing element 34, but the number of lenses constituting the second optical condensing element 35 is not limited to two.

The diffuse reflection element 36 includes a substrate 361 and a diffuse reflection layer 362 provided at a position facing the second optical condensing element 35 on the substrate 361.

The diffuse reflection layer 362 reflects and diffuses the blue light incident from the second optical condensing element 35 at the same diffusion angle as that of the fluorescent light emitted from the wavelength conversion device 4A. That is, the diffuse reflection layer 362 reflects and diffuses the incident light without converting the wavelength of the incident light.

The blue light reflected by the diffuse reflection layer 362 passes through the second optical condensing element 35, then passes through the optical separation section 33, and is incident on the phase difference section 37. That is, the light incident on the phase difference section 37 from the optical separation section 33 is white light in which blue light and fluorescent light are mixed.

The phase difference section 37 converts the white light incident from the optical separation section 33 into mixed s-polarized and p-polarized light. The white illumination light, which was converted as described above, is incident on the homogenization optics system 21.

### Configuration of Wavelength Conversion Device

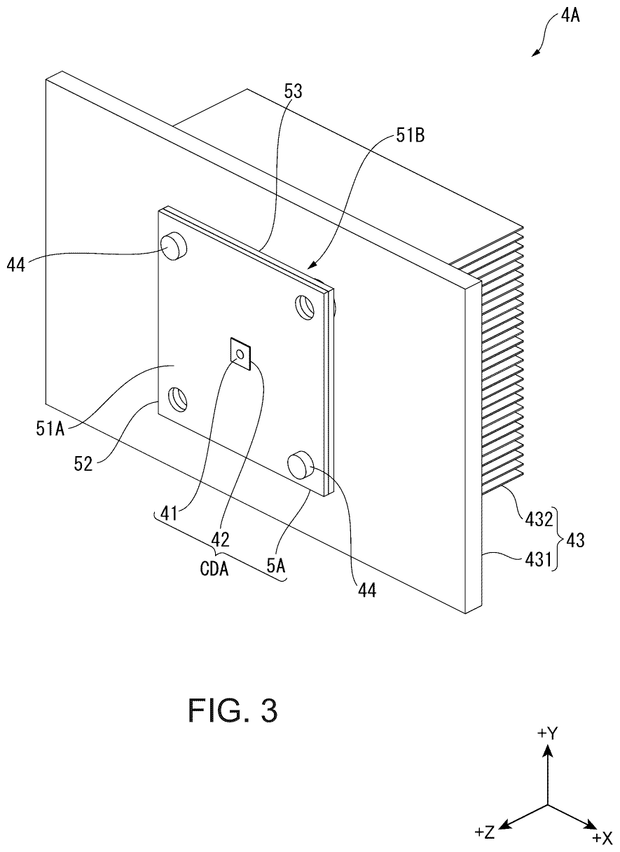

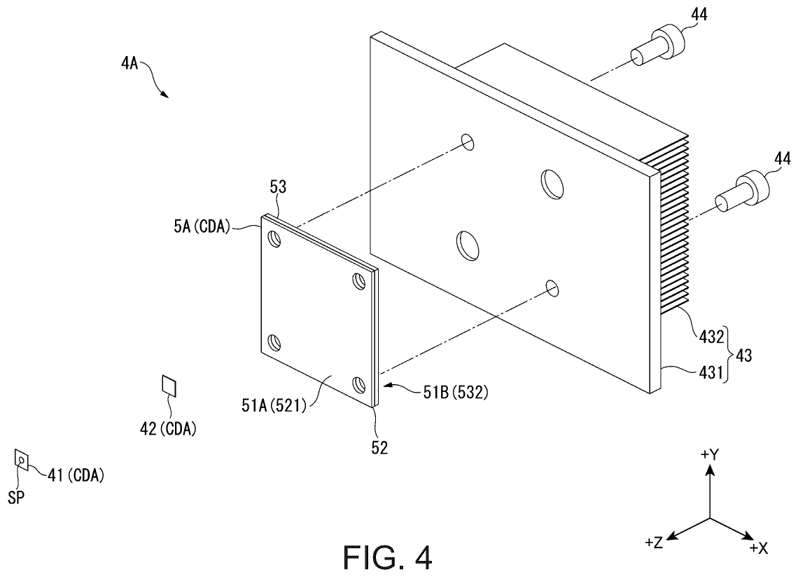

FIG. 3 is a perspective view showing the wavelength conversion device 4A as viewed from the excitation light incident side, and FIG. 4 is an exploded perspective view showing the wavelength conversion device 4A as viewed from the excitation light incident side.

As shown in FIGS. 2 to 4, the wavelength conversion device 4A includes the fluorescent substance 41, bonding material 42, a heat radiation member 43, a fixing member 44, and a vapor chamber 5A.

In the following description, three directions orthogonal to each other are referred to as a +X direction, a +Y direction, and a +Z direction. A direction opposite to the +X direction is defined as a −X direction, a direction opposite to the +Y direction is defined as a −Y direction, and a direction opposite to the +Z direction is defined as a −Z direction.

In the present embodiment, the +Z direction is a direction in which the fluorescent light is emitted from the fluorescent substance 41. That is, the excitation light emitted from the first optical condensing element 34 travels in the −Z direction and is incident on the fluorescent substance 41, and the fluorescent substance 41 emits the fluorescent light in the +Z direction.

The fluorescent substance 41 is provided on a first outer surface 51A of the vapor chamber 5A. More specifically, the fluorescent substance 41 is provided in a placement region 523 of a first surface 521 constituting the first outer surface 51A of a first substrate 52 constituting the vapor chamber 5A. The fluorescent substance 41 includes fluorescent substance particles. The blue light from the light source 31 is incident on the fluorescent substance 41 as excitation light in the −Z direction via the first optical condensing element 34 and the like. The fluorescent substance 41 emits fluorescent light, which is unpolarized light obtained by converting the wavelength of the incident blue light, in the +Z direction. A circle on the fluorescent substance 41 shown in FIGS. 3 and 4 is a spot SP indicating a position on which the excitation light is incident.

In the present embodiment, the fluorescent substance 41 is formed in a rectangular shape when viewed from the +Z direction, but may be formed in a circular shape or another polygonal shape.

The bonding material 42 is a heat conductive bonding material and bonds the first substrate 52 of the vapor chamber 5A and the fluorescent substance 41. The bonding material 42 is formed of, for example, a silver paste containing silver nanoparticles and, after the first substrate 52 and the fluorescent substance 41 are bonded to each other, functions as a reflective layer that reflects the fluorescent light incident from the fluorescent substance 41 toward the fluorescent substance 41. That is, the wavelength conversion device 4A includes a reflective layer arranged between the fluorescent substance 41 and the first substrate 52. The reflective layer may not be formed of the bonding material 42, and may be formed on another surface opposed to one of the fluorescent substance 41 and the first substrate 52. The surface of the first substrate 52 facing the fluorescent substance 41 may function as a reflective layer.

The heat radiation member 43 is coupled in a heat transferable manner to a second outer surface 51B, which is on the opposite side of the vapor chamber 5A than the first outer surface 51A on which the fluorescent substance 41 is provided. The heat radiation member 43 includes a heat receiver plate 431 and a plurality of fins 432.

The heat receiver plate 431 is coupled in a heat transferable manner to the second outer surface 51B via a heat conductive grease or the like, and receives heat radiated from the second outer surface 51B.

Each of the plurality of fins 432 extends from the heat receiver plate 431, in a direction opposite from the vapor chamber 5A. Each of the plurality of fins 432 dissipates heat transferred from the heat receiver plate 431. A cooling gas is circulated through the plurality of fins 432 by a fan (not shown), and thus the heat radiation member 43 and the fluorescent substance 41 are cooled.

The fixing member 44 fixes the heat radiation member 43 to the vapor chamber 5A. Specifically, the fixing member 44 passes through the heat receiver plate 431 and is inserted into the vapor chamber 5A, thereby fixing the heat radiation member 43 to the vapor chamber 5A in a heat transferable manner. In the present embodiment, the wavelength conversion device 4A has two fixing members 44, but the number of fixing members 44 can be changed as appropriate.

### Vapor Chamber Configuration

The vapor chamber 5A supports the fluorescent substance 41 and dissipates heat that is transferred from the fluorescent substance 41 via the bonding material 42 to the heat radiation member 43, thereby cooling the fluorescent substance 41. The vapor chamber 5A constitutes a cooling device CDA together with the fluorescent substance 41 and the bonding material 42. That is, the projector 1 as the electronic device includes the cooling device CDA having the fluorescent substance 41 as the heat-generating body, the bonding material 42, and the vapor chamber 5A.

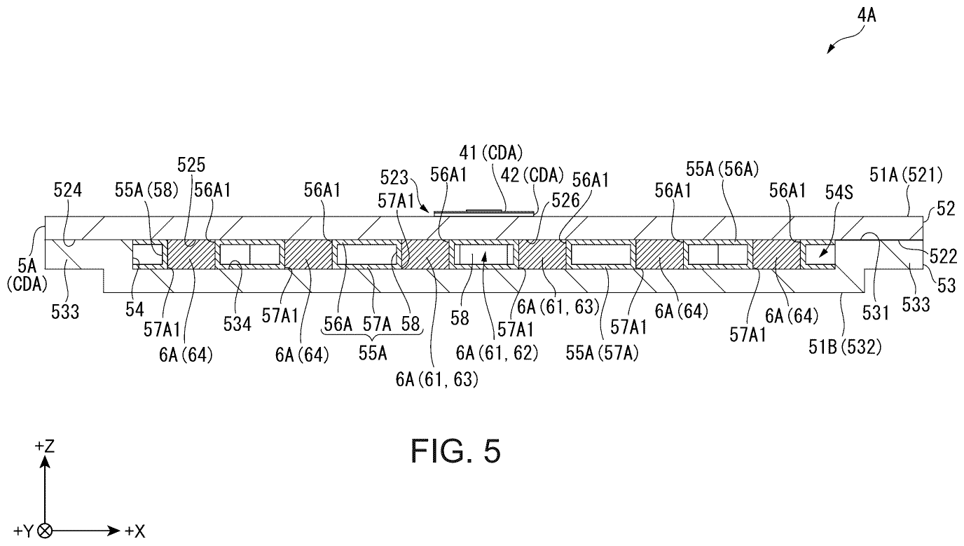

FIG. 5 is a view showing internal structure of the vapor chamber 5A. Specifically, FIG. 5 is a cross-sectional view of the vapor chamber 5A taken along the XZ plane as viewed from the-Y direction.

The vapor chamber 5A includes the first outer surface 51A, the second outer surface 51B, the first substrate 52, and a second substrate 53 as shown in FIGS. 3 to 5, and further includes an accommodation chamber 54, a capillary force structure body 55A, and a plurality of pillars 6A as shown in FIG. 5.

The first outer surface 51A is an outer surface of the vapor chamber 5A facing in the +Z direction.

The second outer surface 51B is an outer surface of the vapor chamber 5A facing in the −Z direction. As described above, the first outer surface 51A and the second outer surface 51B face away from each other on the vapor chamber 5A.

### First Substrate Configuration

The first substrate 52 is a plate-shaped substrate formed of a metal with good thermal conductivity, such as copper. That is, the first substrate 52 exhibits thermal conductivity. As shown in FIG. 5, the first substrate 52 is positioned in the +Z direction with respect to the second substrate 53 and is combined with the second substrate 53 to configure the accommodation chamber 54. The first substrate 52 includes the first surface 521, a second surface 522, the placement region 523, a first peripheral section 524, a first inner surface 525, and a corresponding region 526.

The first surface 521 is a surface facing the +Z direction in the first substrate 52 and constitutes the first outer surface 51A. The placement region 523 is provided on the first surface 521. That is, the placement region 523 is located on the first outer surface 51A.

The placement region 523 is a region in which the fluorescent substance 41 and the bonding material 42 are arranged. In detail, the placement region 523 is a region which overlaps each of the fluorescent substance 41 and the bonding material 42 when viewed from the +Z direction on the first surface 521. For example, when the area of the bonding material 42 is equal to or larger than the area of the fluorescent substance 41, the placement region 523 is a region overlapping the fluorescent substance 41 when viewed from the +Z direction. For example, in a case where the area of the bonding material 42 is smaller than the area of the fluorescent substance 41, the placement region 523 is a region which overlaps the bonding material 42 when viewed from the +Z direction.

The second surface 522 is a surface facing the −Z direction in the first substrate 52.

The first peripheral section 524 is a peripheral portion of the second surface 522. The first peripheral section 524 is bonded to a second peripheral section 533 (to be described later) of the second substrate 53.

The first inner surface 525 is a surface on the inner side of the first peripheral section 524 in the second surface 522, and forms an inner surface on the first substrate 52 side in an accommodation space 54S of the accommodation chamber 54. A first capillary force structure body 56A (to be described later) of the capillary force structure body 55A is provided on the first inner surface 525.

The corresponding region 526 is a region that overlaps the placement region 523 on the first inner surface 525 when viewed from the −Z direction. That is, the corresponding region 526 is a region corresponding to the placement region 523 in the first inner surface 525.

### Second Substrate Configuration

The second substrate 53 is a concave substrate formed of the same material as that of the first substrate 52. That is, the second substrate 53 has thermal conductivity. The thickness dimension of the entire second substrate 53 is greater than the thickness dimension of the entire first substrate 52. The second substrate 53 is positioned in the −Z direction with respect to the first substrate 52, and is combined with the first substrate 52 to form the accommodation chamber 54. The second substrate 53 has a first surface 531, a second surface 532, the second peripheral section 533, and a second inner surface 534.

The first surface 531 is a surface of the second substrate 53 facing in the +Z direction.

The second peripheral section 533 is a portion protruding in the +Z direction from the peripheral portion of the first surface 531. The first peripheral section 524 and the second peripheral section 533 are bonded to each other to form the vapor chamber 5A.

The second inner surface 534 is a surface of the first surface 531 toward the inside from the second peripheral section 533, and forms an inner surface on the second substrate 53 side in the accommodation space 54S of the accommodation chamber 54. The second inner surface 534 is provided with a second capillary force structure body 57A (to be described later) of the capillary force structure body 55A.

The second surface 532 is a surface facing the +Z direction in the second substrate 53, and constitutes the second outer surface 51B. That is, the heat receiver plate 431 of the heat radiation member 43 is coupled to the second surface 532 in a heat transferable manner.

### Accommodation Chamber and Working Medium Configuration

The accommodation chamber 54 has the accommodation space 54S, which is formed between the first substrate 52 and the second substrate 53 by bonding the first peripheral section 524 and the second peripheral section 533. The accommodation space 54S houses the capillary force structure body 55A and the plurality of pillars 6A, and also houses a working medium that transitions into a liquid phase and a gas phase by heat. That is, the vapor chamber 5A includes the working medium accommodated in the accommodation chamber 54.

The working medium is, for example, water, and is sealed in the accommodation chamber 54 in a decompressed state. The working medium transitions from a liquid phase to a gas phase by heat, diffuses throughout the accommodation chamber 54, and then condenses and transitions back from the gas phase to the liquid phase. For example, the working medium in the liquid phase is vaporized by heat transmitted from the heat-generating body disposed in the placement region 523 and is through the accommodation chamber 54 by the heat. The working medium in the gas phase diffused in the accommodation chamber 54 condenses into the working medium in the liquid phase, for example, by transferring heat to the second inner surface 534. The liquid-phase working medium is held by the capillary force structure body 55A (to be described later) and is transported by capillary force to a position in the accommodation chamber 54 where the working medium is easily vaporized. The position where the working medium is easily vaporized is, for example, the corresponding region 526 corresponding to the placement region 523 in which the fluorescent substance 41 as the heat-generating body is arranged.

### Capillary Force Structure Body Configuration

The capillary force structure body 55A holds the working medium in a liquid phase. The capillary force structure body 55A transports the liquid-phase working medium to a position near the fluorescent substance 41, which is a heat-generating body, by capillary forces. As shown in FIG. 5, the capillary force structure body 55A includes the first capillary force structure body 56A, the second capillary force structure body 57A, and a third capillary force structure body 58, and each of the capillary force structure bodies 56A, 57A, and 58 is constituted by, for example, a wick or a mesh.

The first capillary force structure body 56A is provided on the first inner surface 525 and is bonded to the first inner surface 525. In the present embodiment, the first capillary force structure body 56A has a hole section 56A1 through which the pillar 6A (to be described later) is inserted.

The second capillary force structure body 57A is arranged on the second inner surface 534 and bonded to the second inner surface 534. In the present embodiment, the second capillary force structure body 57A has a hole section 57A1 through which a pillar 6A (to be described later) is inserted.

The third capillary force structure body 58 is provided on an outer peripheral surface of a pillar 6A (to be described later). The third capillary force structure body 58 couples the second capillary force structure body 57A with the first capillary force structure body 56A such that liquid phase working medium can move from the second capillary force structure body 57A to the first capillary force structure body 56A via the third capillary force structure body 58.

### Pillar Configuration

The plurality of pillars 6A are disposed between the first inner surface 525 and the second inner surface 534 that constitute the accommodation space 54S of the accommodation chamber 54. In the present embodiment, one end of each of the plurality of pillars 6A is inserted through a hole section 56A1 of the first capillary force structure body 56A in the +Z direction and bonded to the first inner surface 525, and the other end of each of the plurality of pillars 6A is inserted through a hole section 57A1 of the second capillary force structure body 57A in the −Z direction and bonded to the second inner surface 534. The plurality of pillars 6A couple with the first inner surface 525 and the second inner surface 534, and function to maintain the shape of the vapor chamber 5A. For example, the plurality of pillars 6A suppress expansion of the vapor chamber 5A, and also suppress inward deformation of the vapor chamber 5A when a force is applied from the outside.

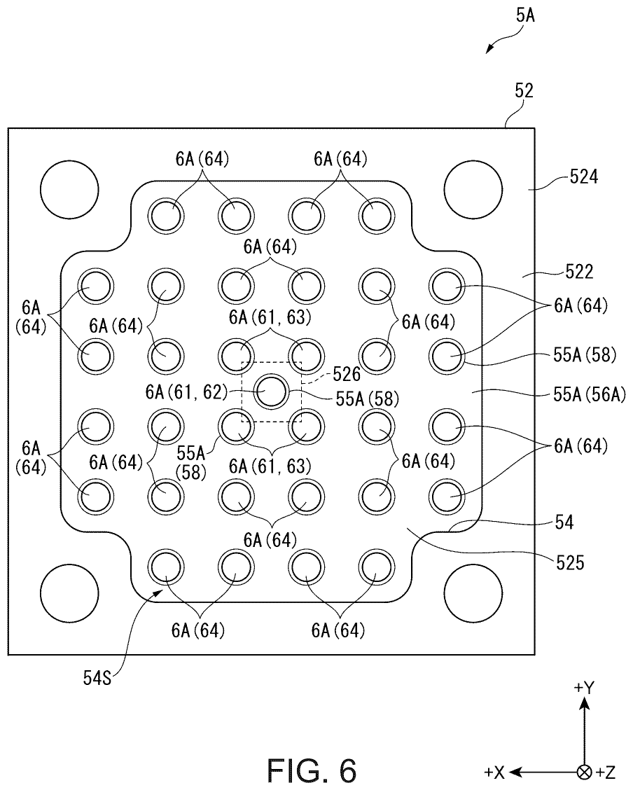

FIG. 6 is a view of the vapor chamber 5A from the −Z direction, showing the state with the second substrate 53 removed.

As shown in FIG. 6, the plurality of pillars 6A include a plurality of inner pillars 61 and a plurality of outer pillars 64.

The plurality of outer pillars 64 are arranged outside the corresponding region 526 in the accommodation chamber 54. A plurality of outer pillars 64 are arranged at substantially equal intervals along the +X direction and the +Y direction in the accommodation chamber 54.

A plurality of inner pillars 61 are arranged in the corresponding region 526 within the accommodation chamber 54. In detail, each of the plurality of inner pillars 61 is arranged so that at least a part thereof is positioned in the corresponding region 526 in the accommodation chamber 54.

The plurality of inner pillars 61 include at least one pillar of at least one of an interior pillar 62 or a peripheral pillar 63. In the present embodiment, the plurality of inner pillars 61 include both interior pillars 62 and peripheral pillars 63.

The interior pillar 62 is an inner pillar which is entirely arranged in the corresponding region 526 when viewed from the second substrate 53 side with respect to the first substrate 52. That is, the entire interior pillar 62 is arranged inside the corresponding region 526 when viewed from the −Z direction.

The peripheral pillar 63 is an inner pillar arranged at the periphery of the corresponding region 526. That is, the peripheral pillar 63 is arranged spanning inside and outside of the corresponding region 526. In the present embodiment, a plurality of peripheral pillars 63 is provided in the corresponding region 526, and the plurality of peripheral pillars 63 is arranged at equal intervals along the periphery of the corresponding region 526. In the present embodiment, as indicated by dotted line in FIG. 6, the periphery of the corresponding region 526 corresponds to the periphery of the placement region 523 in which the fluorescent substance 41 and the bonding material 42 is arranged when viewed from the +Z direction. That is, the peripheral edge of the corresponding region 526 corresponds to the peripheral edge formed by at least one of the peripheral edge of the fluorescent substance 41 or the peripheral edge of the bonding material 42 when viewed from the +Z direction.

Here, the number of inner pillars 61 per unit area in the corresponding region 526 is larger than the number of pillars 6A per unit area in the entire accommodation chamber 54. That is, the number of inner pillars 61 per unit area in the corresponding region 526 is larger than the number of pillars 6A, including both inner pillars 61 and outer pillars 64, per unit area in the entire accommodation chamber 54. In the example of FIG. 6, the number of inner pillars 61 arranged in the corresponding region 526 is five, and the number of pillars 6A in the entire accommodation chamber 54 is 33. The deformation of the vapor chamber 5A is suppressed by the plurality of pillars 6A arranged as described above. In particular, deformation of the vapor chamber 5A in the corresponding region 526 is suppressed.

In the present embodiment, each of an inner pillar 61 and an outer pillar 64 is formed in a cylindrical shape when viewed from the +Z direction. That is, the interior pillars 62, the peripheral pillars 63, and the outer pillars 64 are each formed in a cylindrical shape when viewed from the +Z direction. However, the present disclosure is not limited to this, and at least one of the pillars 62 to 64 may be formed in a prismatic shape. In addition, at least one of the pillars 62 to 64 may be formed in a shape in which the cross-sectional area along the XY plane decreases toward the center in the +Z direction and increases toward the +Z direction and the −Z direction from the center in the +Z direction.

### Effects of First Embodiment

The projector 1 according to the present embodiment described above has the following effects.

The projector 1 as the electronic device includes a cooling device CDA.

The cooling device CDA includes the vapor chamber 5A and the fluorescent substance 41 bonded to a placement region 523 of the vapor chamber 5A. The fluorescent substance 41 corresponds to a heat-generating body.

The vapor chamber 5A includes the first substrate 52, the second substrate 53, the accommodation chamber 54, the working medium, and the plurality of pillars 6A.

Both the first substrate 52 and the second substrate 53 have thermal conductivity. The second substrate 53 faces the first substrate 52 in the +Z direction.

The accommodation chamber 54 has an accommodation space 54S which is formed by bonding the first peripheral section 524 of the first substrate 52 and the second peripheral section 533 of the second substrate 53.

The working medium is accommodated in the accommodation chamber 54 and transitions into a gas phase or a liquid phase by heat.

The plurality of pillars 6A are arranged in the accommodation chamber 54 between the first inner surface 525 and the second inner surface 534, which is an inner surface of the second substrate 53. The first inner surface 525 is an inner surface of the first substrate 52 and, of the inner surface of the accommodation chamber 54, is the inner surface that is configured by the first substrate 52 and that faces the second substrate 53. The second inner surface 534 is an inner surface of the second substrate 53, is configured by the second substrate 53, and is an inner surface that faces the first substrate 52.

The first substrate 52 includes the placement region 523 and the corresponding region 526.

The placement region 523 is located on the first surface 521 that forms the first outer surface 51A of the vapor chamber 5A. That is, the placement region 523 is positioned on the outer surface of the first substrate 52. In the placement region 523, the fluorescent substance 41, which is a heat-generating body, is arranged.

The corresponding region 526 is located on the first inner surface 525 and corresponds to the placement region 523.

The plurality of pillars 6A include at least one inner pillar 61 and the plurality of outer pillars 64.

The inner pillar 61 is arranged in the corresponding region 526.

The outer pillars 64 are arranged outside the corresponding region 526.

The number of inner pillars 61 per unit area in the corresponding region 526 is larger than the number of pillars 6A per unit area in the entire accommodation chamber 54.

According to the configuration of the vapor chamber 5A, the number of inner pillars 61 per unit area in the corresponding region 526 is larger than the number of pillars 6A per unit area in the entire accommodation chamber 54. It is possible to increase the pressure resistance against the expansion of the vapor chamber 5A in the corresponding region 526. Even when a thermal load is applied to the placement region 523 from the outside, the vapor chamber 5A can be prevented from expanding.

On the other hand, the number per unit area of the outer pillars 64 arranged outside the corresponding region 526 is smaller than the number per unit area of the inner pillars 61 arranged in the corresponding region 526. Therefore, in the corresponding region 526 located on the first inner surface 525, the working fluid transitioned from the liquid phase to the gas phase by the heat transmitted from the fluorescent substance 41 as the heat-generating body can be easily diffused to the outside of the corresponding region 526.

Therefore, it is possible to suppress expansion and deformation of the vapor chamber 5A while maintaining diffusibility of the working medium in the vapor chamber 5A. Accordingly, the cooling device CDA including the vapor chamber 5A can be a cooling device capable of suppressing expansion of the vapor chamber 5A while cooling the fluorescent substance 41. Further, since the projector 1, which is the electronic device, is provided with the cooling device CDA, it is possible to provide a projector that can operate stably.

The projector 1 further includes the light source 31, the wavelength conversion device 4A on which light from the light source 31 is incident as exciting light, the image forming device 24, and the projection optical device 26.

The image forming device 24 forms image light from the light including the fluorescent light emitted from the fluorescent substance 41 of the wavelength conversion device 4A. The projection optical device 26 projects the image light.

The wavelength conversion device 4A includes the cooling device CDA. A heat-generating body arranged in the placement region 523 of the first substrate 52 constituting the vapor chamber 5A of a cooling device CDA is the fluorescent substance 41 for emitting fluorescent light by converting wavelengths of incident light. The fluorescent substance 41 is bonded to the placement region 523 via the thermal conductivity bonding material 42.

According to such a configuration, since it is possible to stably cool the fluorescent substance 41, it is possible to configure the wavelength conversion device 4A capable of stably emitting the fluorescent light, and thus it is possible to configure the projector 1 capable of stably operating.

At the vapor chamber 5A, the inner pillar 61 includes the interior pillar 62. The entire interior pillar 62 is disposed in the corresponding region 526 when viewed from the second substrate 53 side with respect to the first substrate 52.

According to such a configuration, it is possible to suppress the expansion of the portion corresponding to the placement region 523 in the vapor chamber 5A by the interior pillar 62, which is entirely arranged in the corresponding region 526. Therefore, the pressure resistance strength of the vapor chamber 5A can be increased.

In the vapor chamber 5A, the inner pillar 61 includes a peripheral pillar 63 arranged at the periphery of the corresponding region 526. The peripheral pillar 63 is arranged spanning inside and outside of the corresponding region 526.

According to such a configuration, it is possible to suppress expansion of the peripheral portion of the placement region 523 due to heat acting on the placement region 523 from the outside by the peripheral pillar 63. Therefore, the pressure resistance strength of the vapor chamber 5A can be increased.

In the vapor chamber 5A, a plurality of peripheral pillars 63 are provided at equal intervals on the periphery of the corresponding region 526. A plurality of outer pillars 64 are arranged at equal intervals. That is, among the plurality of outer pillars 64, the outer pillars 64 arranged around the inner pillar 61 are arranged at equal intervals.

According to such a configuration, since the plurality of peripheral pillars 63 are provided at equal intervals on the periphery of the corresponding region 526, it is possible to effectively suppress the expansion of the portion corresponding to the placement region 523 in the vapor chamber 5A. Therefore, the flatness of the vapor chamber 5A can be reduced.

Further, since the plurality of outer pillars 64 arranged around the inner pillar 61 are arranged at equal intervals, it is possible to suppress the diffusion of the working medium vaporized in the corresponding region 526 to the outside of the corresponding region 526 from being hindered by the plurality of outer pillars 64.

The vapor chamber 5A is arranged on the first inner surface 525 in the accommodation chamber 54 and includes a first capillary force structure body 56A that holds the liquid-phase working medium.

According to such a configuration, the liquid-phase working medium can be easily supplied to the corresponding region to which the heat from the heat-generating body is transmitted. Therefore, the efficiency of heat transfer from the heat-generating body to the working medium can be enhanced, and the efficiency of cooling of the heat-generating body can be enhanced.

In the vapor chamber 5A, the inner pillar 61 is bonded to the first inner surface 525 while avoiding the first capillary force structure body 56A. That is, the first capillary force structure body 56A has the hole section 56A1, and the inner pillar 61 is bonded to the first inner surface 525 through the hole section 56A1.

According to such a configuration, the inner pillar 61 can be directly bonded to the first inner surface 525. Therefore, the bonding strength between the inner pillar 61 and the first inner surface 525 can be increased, and the pressure resistance of the vapor chamber 5A can be further increased.

The vapor chamber 5A includes the second capillary force structure body 57A and the third capillary force structure body 58. The second capillary force structure body 57A is arranged on the second inner surface 534 inside the accommodation chamber 54 and holds the working medium in the liquid phase. The third capillary force structure body 58 is provided on the outer surface of each pillar 6A and couples the first capillary force structure body 56A with the second capillary force structure body 57A. For example, the third capillary force structure body 58 is arranged on the outer surface of the inner pillar 61 and couples the first capillary force structure body 56A with the second capillary force structure body 57A.

According to such a configuration, the liquid-phase working medium transported by the second capillary force structure body 57A can be supplied to the first capillary force structure body 56A via the third capillary force structure body 58, and thus the liquid-phase working medium can be easily supplied to the corresponding region 526. Therefore, the efficiency of heat transfer from the fluorescent substance 41, which is a heat-generating body, to the liquid-phase working medium can be further increased, and the efficiency of cooling of the fluorescent substance 41 can be increased.

### Modifications of First Embodiment

In the vapor chamber 5A, one end of each pillar 6A is bonded to the first inner surface 525 through the hole section 56A1 of the first capillary force structure body 56A, and the other end of each pillar 6A is bonded to the second inner surface 534 through the hole section 57A1 of the second capillary force structure body 57A. However, the present disclosure is not limited to this, and the bonded state of the plurality of pillars 6A and the first substrate 52 and the second substrate 53 is not limited to the above.

### First Modification of First Embodiment

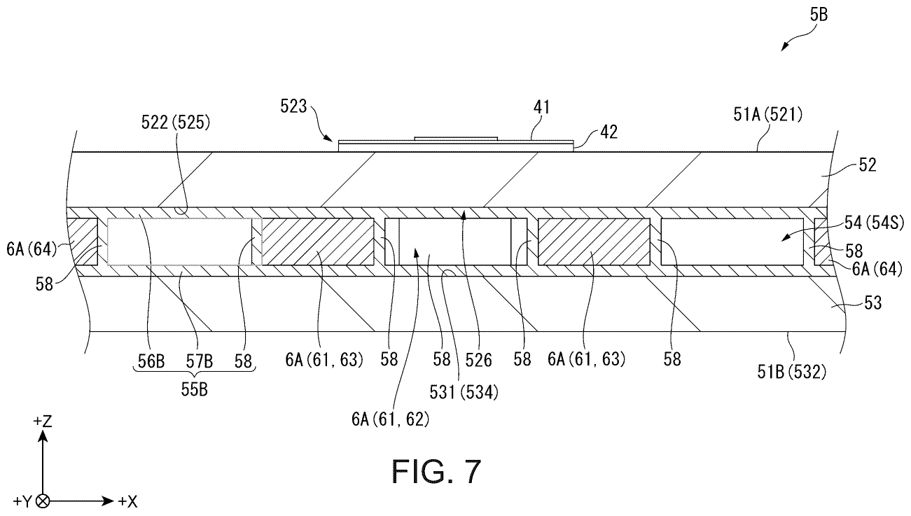

FIG. 7 is a view showing a part of a cross section along the XZ plane of a vapor chamber 5B which is a first modification of the vapor chamber 5A.

The vapor chamber 5B shown in FIG. 7 has the same configuration and function as those of the vapor chamber 5A described above except that a capillary force structure body 55B is provided instead of the capillary force structure body 55A. The capillary force structure body 55B includes a first capillary force structure body 56B and a second capillary force structure body 57B instead of the first capillary force structure body 56A and the second capillary force structure body 57A, and further includes the third capillary force structure body 58, and functions in the same manner as the capillary force structure body 55A.

The first capillary force structure body 56B is bonded to the first inner surface 525, and the second capillary force structure body 57B is bonded to the second inner surface 534. Here, the first capillary force structure body 56B is not provided with the hole section 56A1, and the second capillary force structure body 57B is not provided with the hole section 57A1. For this reason, an end section in the +Z direction, which is one end, of the pillar 6A is bonded to the surface of the first capillary force structure body 56B that faces the −Z direction, and an end section in the −Z direction, which is the other end, of the pillar 6A is bonded to the surface of the second capillary force structure body 57B that faces the +Z direction. In the example of FIG. 7, one end of the inner pillar 61 is bonded to the first inner surface 525 via the first capillary force structure body 56B, and the other end of the inner pillar 61 is bonded to the second inner surface 534 via the second capillary force structure body 57B.

The vapor chamber 5B described above has effects described below in addition to the same effects as the vapor chamber 5A.

In the vapor chamber 5B, the at least one inner pillar 61 is bonded to the first inner surface 525 of the first substrate 52 via the first capillary force structure body 56B.

According to such a configuration, it is possible to suppress a decrease in the areas of the first capillary force structure body 56B due to the inner pillar 61, and therefore, it is possible to suppress a decrease of the ability of the first capillary force structure body 56B to retain, and the ability to transport, the working medium in the liquid phase. Therefore, the liquid-phase working medium can be efficiently transported to the corresponding region 526, and thus the efficiency of heat transfer from the fluorescent substance 41, which is a heat-generating body, to the liquid-phase working medium can be increased.

### Second Modification of First Embodiment

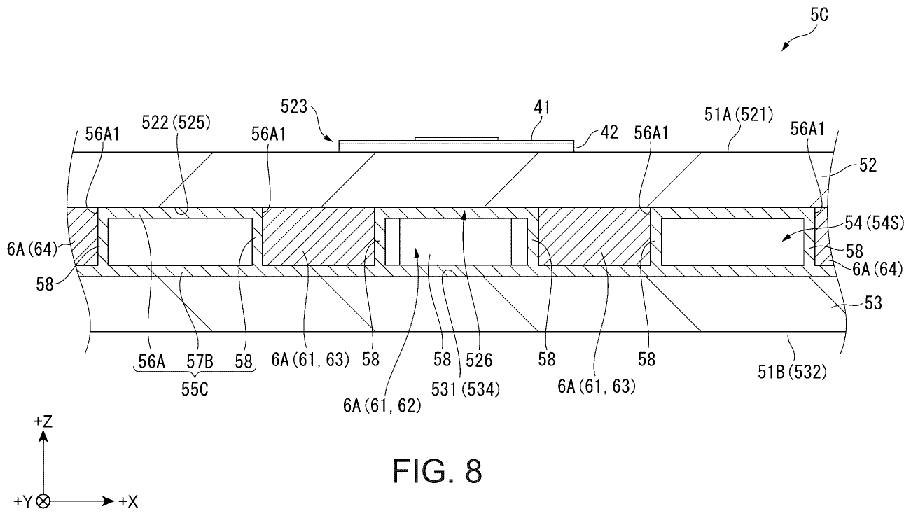

FIG. 8 is a view showing a part of a cross section along the XZ plane of a vapor chamber 5C, which is a second modification of the vapor chamber 5A.

One of the first capillary force structure bodies 56A and 56B may be combined with one of the second capillary force structure bodies 57A and 57B.

The vapor chamber 5C shown in FIG. 8 has the same configuration and function as the vapor chamber 5A described above, except that a capillary force structure body 55C is provided instead of the capillary force structure body 55A. The capillary force structure body 55C comprises the first capillary force structure body 56A, the second capillary force structure body 57B, and the third capillary force structure body 58, and functions in the same way as the capillary force structure body 55A.

In the vapor chamber 5C, one end of each pillar 6A is inserted through the hole section 56A1 of the first capillary force structure body 56A and bonded to the first inner surface 525, and the other end of the pillar 6A is bonded to a surface of the second capillary force structure body 57B facing the +Z direction. For example, one end of each pillar 6A is bonded to the first inner surface 525 while avoiding the first capillary force structure body 56A, and the other end of each pillars 6A is bonded to the second inner surface 534 via the second capillary force structure body 57B. In the example of FIG. 8, one end of the inner pillar 61 is bonded to the first inner surface 525 while avoiding the first capillary force structure body 56A, and the other end of the inner pillar 61 is bonded to the second inner surface 534 via the second capillary force structure body 57B.

The vapor chamber 5C, as described above, has the following effects in addition to the same effects as the vapor chamber 5A.

The vapor chamber 5C includes the second capillary force structure body 57B, which is arranged on the second inner surface 534 within the accommodation chamber 54 and retains the liquid-phase working medium.

One end of the inner pillar 61 is bonded to the first inner surface 525 while avoiding the first capillary force structure body 56A, and the other end of the inner pillar 61 is bonded to the second inner surface 534 via the second capillary force structure body 57B. The first inner surface 525 corresponds to the inner surface of the first substrate 52, and the second inner surface 534 corresponds to the inner surface of the second substrate 53.

According to such a configuration, one end of the inner pillar 61 can be directly bonded to the first inner surface 525. Therefore, it is possible to increase the bonding strength between the inner pillar 61 and the first inner surface 525.

Since the inner pillar 61 can suppress a decrease in the area size of the second capillary force structure body 57B, it is possible to suppress a decrease in the ability of the second capillary force structure body 57B to retain and the ability of transport the liquid-phase working medium.

Therefore, the pressure-resistant strength of the vapor chamber 5C can be further increased, and the liquid-phase working medium can be efficiently transported toward the corresponding region 526. Therefore, heat can be efficiently transferred from the fluorescent substance 41, which is a heat-generating body, to the liquid-phase working medium.

### Second Embodiment

Next, a second embodiment of the present disclosure will be described.

The projector according to the present embodiment has the same configuration as that of the projector 1 according to the first embodiment, but the cross-sectional area of the pillar arranged in the accommodation chamber of the vapor chamber is different. In the following description, the same or substantially the same parts as those described above are denoted by the same reference numerals, and the description thereof will be omitted.

### Schematic Configuration of Projector and Wavelength Conversion Device

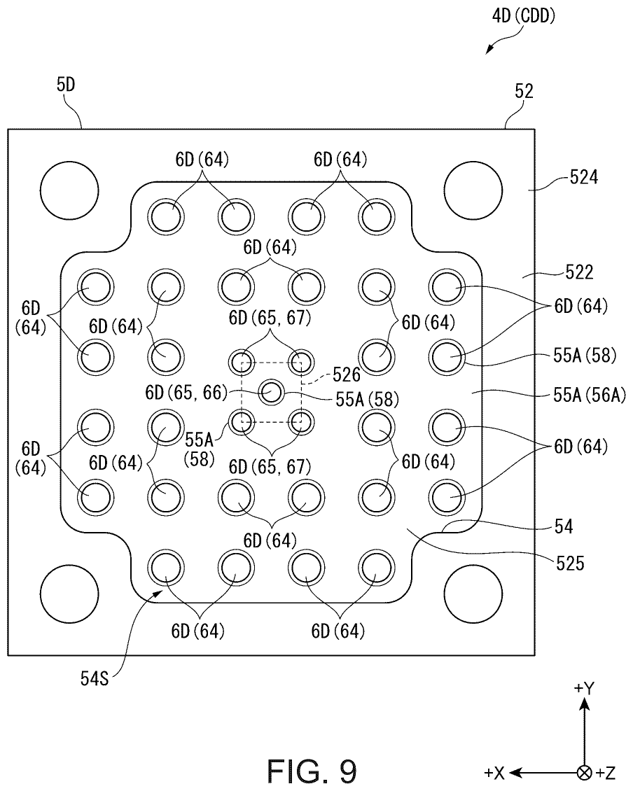

FIG. 9 is a diagram showing an internal structure of a vapor chamber 5D of a wavelength conversion device 4D included in the projector according to the present embodiment. In detail, FIG. 9 is a view of the vapor chamber 5D with the second substrate 53 removed, as viewed from the −Z direction.

The projector according to the present embodiment has the same configuration and function as those of the projector 1 according to the first embodiment except that the projector according to this embodiment includes the wavelength conversion device 4D shown in FIG. 9 instead of the wavelength conversion device 4A.

The wavelength conversion device 4D has the same configuration and function as the wavelength conversion device 4A according to the first embodiment, except that the wavelength conversion device 4D includes the vapor chamber 5D instead of the vapor chamber 5A. That is, the wavelength conversion device 4D according to the present embodiment includes the cooling device CDD instead of the cooling device CDA, and further includes the heat radiation member 43.

The cooling device CDD has the same configuration and function as those of the cooling device CDA according to the first embodiment except that the cooling device CDD includes the vapor chamber 5D instead of the vapor chamber 5A. That is, the cooling device CDD according to the present embodiment includes the fluorescent substance 41, the bonding material 42, and the vapor chamber 5D, and functions similarly to the cooling device CDA.

### Vapor Chamber Configuration

The vapor chamber 5D has the same configuration and function as the vapor chamber 5A, except that the vapor chamber 5D includes a plurality of pillars 6D instead of the plurality of pillars 6A. That is, the vapor chamber 5D includes the first outer surface 51A, the second outer surface 51B, the first substrate 52, the second substrate 53, the accommodation chamber 54, the capillary force structure body 55A, and the plurality of pillars 6D. The vapor chamber 5D may include the capillary force structure body 55B or the capillary force structure body 55C instead of the capillary force structure body 55A.

### Configuration of Plural Pillars

The plurality of pillars 6D include a plurality of outer pillars 64, in addition to a plurality of inner pillars 65 instead of the inner pillar 61, and have the same function as the pillars 6A according to the first embodiment.

Similarly to the plurality of inner pillars 61, the plurality of inner pillars 65 are provided in the corresponding region 526 of the first substrate 52. In detail, each of the plurality of inner pillars 65 is arranged so that at least a part thereof is positioned in the corresponding region 526 in the accommodation chamber 54. An end section of each of the plurality of inner pillars 65 in the +Z direction is directly bonded to the corresponding region 526 of the first inner surface 525 while avoiding the first capillary force structure body 56A, or is bonded to the corresponding region 526 via the first capillary force structure body 56B. Although not shown, an end section of each of the plurality of inner pillars 65 in the −Z direction is directly bonded to the second inner surface 534 while avoiding the second capillary force structure body 57A, or is bonded to the second inner surface 534 via the second capillary force structure body 57B.

The placement position of an inner pillar 65 in the corresponding region 526 is the same as the placement position of the inner pillar 61 in the corresponding region 526 shown in the first embodiment. That is, the plurality of inner pillars 65 include at least one pillar of at least one of interior pillars 66 arranged at the same position as the interior pillar 62 and the peripheral pillar 67 arranged at the same position as the peripheral pillar 63. In the present embodiment, the plurality of inner pillars 65 includes the interior pillars 66 and the peripheral pillars 67.

A cross-sectional area along the first inner surface 525 of a portion of the inner pillar 65 on the first substrate 52 side is smaller than a cross-sectional area along the first inner surface 525 of a portion of the outer pillar 64 on the first substrate 52 side. That is, the cross-sectional area along the first inner surface 525 of the portion of the interior pillar 66 on the first substrate 52 side is smaller than the cross-sectional area along the first inner surface 525 of the portion of the outer pillar 64 on the first substrate 52 side. The cross-sectional area along the first inner surface 525 of the portion of the peripheral pillar 67 on the first substrate 52 side is smaller than the cross-sectional area along the first inner surface 525 of the portion of the outer pillar 64 on the first substrate 52 side.

In other words, the cross-sectional area of the inner pillar 65 orthogonal to the central axis of each inner pillar 65 is smaller than the cross-sectional area of the outer pillar 64 orthogonal to the central axis of each outer pillar 64.

Although not shown, the cross-sectional area along the second inner surface 534 at the end section of the inner pillar 65 on the second substrate 53 side is smaller than the cross-sectional area along the second inner surface 534 at the end section of the outer pillar 64 on the second substrate 53 side.

As described above, the arrangement of the inner pillar 65 in the corresponding region 526 is the same as the arrangement of the inner pillar 61 in the corresponding region 526 of the vapor chamber 5A. The arrangement of the outer pillars 64 in the accommodation chamber 54 is the same as the arrangement of the outer pillars 64 in the accommodation chamber 54 of the vapor chamber 5A. Therefore, the number of inner pillars 65 per unit area in the corresponding region 526 is larger than the number of pillars 6D, which includes both inner pillars 65 and outer pillars 64, per unit area in the entire accommodation chamber 54.

On the other hand, since the cross-sectional area of the inner pillar 65 is smaller than the cross-sectional area of the outer pillar 64, the area occupied by the inner pillar 65 in the corresponding region 526 where the working medium changes from the liquid phase to the gas phase can be reduced. For this reason, the working medium can be easily changed from the liquid phase to the gas phase in the corresponding region 526, and the working medium changed from the liquid phase to the gas phase in the corresponding region 526 can be easily diffused to the outside of the corresponding region 526 and further to the entire accommodation chamber 54.

### Effects of Second Embodiment

The projector according to the present embodiment described above has the following effects in addition to the effects similar to those of projector 1 according to the first embodiment.

In the vapor chamber 5D, a cross-sectional area along the first inner surface 525 in a portion of the inner pillar 65 on the first substrate 52 side is smaller than a cross-sectional area along the first inner surface 525 in a portion of each outer pillar 64 on the first substrate 52 side.

According to such a configuration, it is possible to suppress the area of the portion where the working medium in the liquid phase is changed to the working medium in the gas phase by the heat transmitted from the fluorescent substance 41, which is the heat-generating body, in the corresponding region 526 from being reduced by the inner pillar 65, and thus, it is possible to suppress the heat transfer from the first inner surface 525 to the working medium in the liquid phase from being hindered. Therefore, it is possible to suppress a decrease in the efficiency of heat transfer from the fluorescent substance 41 to the liquid-phase working medium.

### Third Embodiment

Next, a third embodiment of the present disclosure will be described.

The projector according to the present embodiment has a configuration similar to that of the projector 1 according to the first embodiment, but differs from the projector 1 in that the placement region in which the heat-generating body is arranged in the vapor chamber is formed by a recessed section provided in the first substrate. In the following description, the same or substantially the same parts as those described above are denoted by the same reference numerals, and the description thereof will be omitted.

### Schematic Configuration of Projector and Wavelength Conversion Device

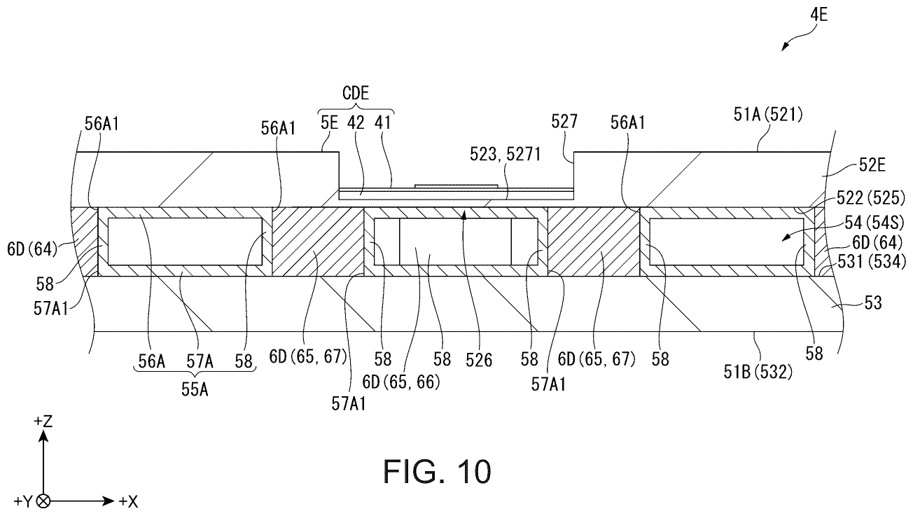

FIG. 10 is a view showing a cross section along the XZ plane of a vapor chamber 5E of the wavelength conversion device 4E included in the projector according to the present embodiment.

The projector according to the present embodiment has the same configuration and function as those of the projector 1 according to the first embodiment except that the wavelength conversion device 4E shown in FIG. 10 is provided instead of the wavelength conversion device 4A.

The wavelength conversion device 4E has the same configuration and function as the wavelength conversion device 4A according to the first embodiment, except that the wavelength conversion device 4E includes the vapor chamber 5E instead of the vapor chamber 5A. That is, the wavelength conversion device 4E according to the present embodiment includes the cooling device CDE instead of the cooling device CDA, and also includes the heat radiation member 43 not shown in FIG. 10.

The cooling device CDE according to the present embodiment includes the fluorescent substance 41, the bonding material 42, and the vapor chamber 5E, and functions similarly to the cooling device CDA.

### Vapor Chamber Configuration

The vapor chamber 5E has the same configuration as the vapor chamber 5D according to the second embodiment, except that the vapor chamber 5E includes a first substrate 52E instead of the first substrate 52. That is, the vapor chamber 5E may include the first outer surface 51A, the second outer surface 51B, the first substrate 52E, the second substrate 53, the accommodation chamber 54, the capillary force structure body 55A, and the plurality of pillars 6D. The vapor chamber 5E may include the capillary force structure body 55B or the capillary force structure body 55C instead of the capillary force structure body 55A.

### First Substrate Configuration

Similar to the first substrate 52 according to the first embodiment, the first substrate 52E has thermal conductivity and is combined with the second substrate 53 positioned in the −Z direction with respect to the first substrate 52E to form the accommodation chamber 54. The first substrate 52E includes the first surface 521, the second surface 522, the placement region 523, the first peripheral section 524, the first inner surface 525, and the corresponding region 526, and further includes a placement recessed section 527.

The placement recessed section 527 is a recessed section recessed in the −Z direction which is the second substrate 53 side from the first surface 521. The bonding material 42 is arranged on the bottom surface 5271 facing the +Z direction in the placement recessed section 527, and thus the fluorescent substance 41 is arranged on a bottom surface 5271. That is, in the present embodiment, the placement region 523 is located on the bottom surface of the placement recessed section 527.

For this reason, the thickness dimension of the first substrate 52E in the placement region 523 is smaller than the thickness dimension of the first substrate 52E around the placement region 523. In the present embodiment, the +Z direction dimension of the bottom surface 5271 of the placement recessed section 527 is 0.15 mm or more and 0.60 mm or less, whereas the +Z direction dimension of the first substrate 52E is 0.80 mm or more and 2.00 mm or less. That is, the thickness dimension of the first substrate 52E in the placement region 523 is 0.15 mm or more and 0.60 mm or less, whereas the thickness dimension of the first substrate 52E around the placement region 523 is 0.80 mm or more and 2.00 mm or less.

### Effects of Third Embodiment

The projector according to the present embodiment described above, in addition to the effects similar to those of the projector according to the second embodiment, has the following effects.

In the vapor chamber 5E, the thickness dimension of the first substrate 52E in the placement region 523 is smaller than the thickness dimension of the first substrate 52E around the placement region 523.

According to the present configuration, it is possible to efficiently transfer heat from the fluorescent substance 41, which is the heat-generating body, to the first inner surface 525 of the first substrate 52E, and thus to efficiently transfer heat from the fluorescent substance 41 to the liquid-phase working medium. Therefore, the heat of the fluorescent substance 41 can be efficiently transferred to the liquid-phase working medium, and the cooling efficiency of the fluorescent substance 41 can be increased.

### Modifications of Embodiments

The present disclosure is not limited to the above-described embodiments, and modifications, improvements, and the like within a range in which the object of the present disclosure can be achieved are included in the present disclosure.

In each of the above-described embodiments, the inner pillars 61 and 65, which are at least partially disposed in the corresponding region 526 corresponding to the placement region 523, include the interior pillars 62 and 66, and the interior pillars 62 and 66 are entirely disposed within the corresponding region 526 when viewed from the second substrate 53 side with respect to the first substrates 52 and 52E. However, the present disclosure is not limited to this, and the interior pillars 62 and 66 can be omitted if the number per unit area of inner pillars 61 and 65 in the corresponding region 526 is higher than the number per unit area of pillars 6A and 6D in the entire accommodation chamber 54.

On the other hand, in each of the above embodiments, one interior pillar 62 or 66 is provided in the corresponding region 526. However, the present disclosure is not limited to this, and a plurality of interior pillars 62 and 66 may be provided in the corresponding region 526.

In each of the above-described embodiments, the inner pillars 61 and 65, at least a part of which is arranged in the corresponding region 526 corresponding to the placement region 523, include a plurality of peripheral pillars 63, and the peripheral pillars 63 are arranged spanning inside and outside of the corresponding region 526. However, the present disclosure is not limited to this, and if the number per unit area of the inner pillars 61 and 65 in the corresponding region 526 is greater than the number per unit area of pillars 6A and 6D in the entire accommodation chamber 54, the peripheral pillars 63 may be omitted.

In each of the embodiments described above, peripheral pillars 63 are provided at corner sections of the corresponding region 526 when viewed from the second substrate 53 side with respect to the first substrates 52 and 52E, and are arranged at equal intervals along the periphery of the corresponding region 526. However, the present disclosure is not limited to this, and the number and arrangement of the peripheral pillars 63 are not limited to the above and may be changed as appropriate.

In each of the above-described embodiments, the outer pillars 64 are arranged at equal intervals in the accommodation chamber 54 except for the corresponding region 526. However, the present disclosure is not limited to this, and the outer pillars 64 may be randomly arranged in the accommodation chamber 54 except for the corresponding region 526. That is, the arrangement and the number of the outer pillar 64 are not limited to the above.

In each of the embodiments described above, either of the first capillary force structure bodies 56A and 56B is provided on the first inner surface 525, either of the second capillary force structure bodies 57A and 57B is provided on the second inner surface 534, and the third capillary force structure bodies 58 are provided on the outer peripheral surfaces of the pillars 6A and 6D. However, the present disclosure is not limited to this, and at least one of the first capillary force structure bodies 56A and 56B, the second capillary force structure bodies 57A and 57B, and the third capillary force structure body 58 may be omitted.

The first capillary force structure bodies 56A and 56B may not be provided on the entire first inner surface 525, and may be provided on a part of the first inner surface 525. Similarly, the second capillary force structure body 57A, 57B may not be provided on the entire second inner surface 534, but may be provided on a part of the second inner surface 534.

Further, the third capillary force structure body 58 may not be provided in all of the plurality of pillars 6A and 6D, and may be provided only in the inner pillars 61 and 65, for example.

In each of the embodiments described above, the projector includes the three optical modulation elements 243R, 243G, and 243B. However, the disclosure is not limited to this, and the disclosure can also be applied to a projector including two or fewer, or four or more optical modulation elements.

In each of the embodiments described above, the optical modulation element 243 is a transmissive liquid crystal panel in which the light incident surface and the light emitting surface are different. However, the present disclosure is not limited to this, and the optical modulation element 243 may be a reflective liquid crystal panel in which the light incident surface and the light emitting surface are the same. If the optical modulation element can modulate an incident light beam to form an image corresponding to image information, an optical modulation element other than liquid crystal, such as a device using a micromirror, for example, a digital micromirror device (DMD), may be adopted as the optical modulation element 243.

In each of the above-described embodiments, the vapor chambers 5A, 5B, 5C, 5D, and 5E constitute the wavelength conversion devices 4A, 4D, and 4E, and the heat-generating body arranged in the placement region 523 of the vapor chambers 5A, 5B, 5C, 5D, and 5E is the fluorescent substance 41. However, the present disclosure is not limited to this, and the heat-generating body provided in the placement region of the vapor chamber according to the present disclosure is not limited to a fluorescent substance, and may be another heat-generating body such as a solid-state light emitting element or a semiconductor element.

In each of the embodiments described above, the projector 1 including the light source 31, the image forming device 24, and the projection optical device 26 has been exemplified as the electronic device including the cooling devices CDA and CDE. However, the electronic device including the vapor chamber of the present disclosure is not limited to this, and may be another electronic devices such as the information process device or the light source device.

### Summary of the Present Disclosure

Hereinafter, a summary of the present disclosure is appended.

### Appendix 1

A vapor chamber includes
a first substrate that has thermal conductivity;
a second substrate that faces the first substrate and that has thermal conductivity;
an accommodation chamber including an accommodation space configured by bonding together a peripheral section of the first substrate and a peripheral section of the second substrate;
a working medium that is accommodated in the accommodation chamber and that transitions between a gas phase and a liquid phase by heat; and
a plurality of pillars between inner surfaces of the first and second substrates within the accommodation chamber, wherein
the first substrate includes
   a placement region that is located on an outer surface of the first substrate and on which a heat-generating body is arranged and
   a corresponding region that is located on an inner surface of the first substrate and that corresponds to the placement region,
the pillars include
   at least one inner pillar arranged in the corresponding region and
   a plurality of outer pillars arranged outside the corresponding region, and
the number of inner pillars per unit area in the corresponding region is larger than the number of pillars per unit area in the entire accommodation chamber.

According to such a configuration, the number of inner pillars per unit area in the corresponding region is larger than the number of pillars per unit area in the entire accommodation chamber. With this configuration, it is possible to increase the pressure resistance against the expansion of the vapor chamber in the corresponding region. By this, even when a thermal load is applied to the placement region from the outside, it is possible to suppress expansion of the vapor chamber.

On the other hand, since the number of outer pillars per unit area disposed outside the corresponding region is smaller than the number of inner pillars per unit area disposed in the corresponding region, the working fluid changed from the liquid phase to the gas phase by the heat transmitted from the heat-generating body can easily diffuse to the outside of the corresponding region in the corresponding region located on the inner surface of the first substrate.

Therefore, it is possible to suppress the expansion of the vapor chamber while maintaining the diffusibility of the working medium in the vapor chamber.

### Appendix 2

The vapor chamber according to appendix 1, wherein
a cross-sectional area along the inner surface of the first substrate in a portion of at least one inner pillar on the first substrate side is smaller than a cross-sectional area along the inner surface of the first substrate in a portion of each of the plurality of outer pillars on the first substrate side.

According to such a configuration, it is possible to prevent reduction of the area where working medium in the liquid phase is converted to working medium in the gas phase by heat transferred from the heat-generating body in the corresponding region due to the inner pillar, and thus, it is possible to prevent the heat transfer from the inner surface of the first substrate to the working medium in the liquid phase from being obstructed. Therefore, it is possible to suppress a decrease in the efficiency of heat transfer from the heat-generating body to the working medium in a liquid phase.

### Appendix 3

The vapor chamber according to appendix 1 or 2, wherein
the thickness dimension of the first substrate at the placement region is smaller than the thickness dimension of the first substrate surrounding the placement region.

According to such a configuration, the efficiency of heat transfer from the heat-generating body to the inner surface of the first substrate, and hence the efficiency of heat transfer from the heat-generating body to the working medium in a liquid phase can be improved. Therefore, the heat of the heat-generating body can be efficiently transferred to the working medium in a liquid phase, and the cooling efficiency of the heat-generating body can be enhanced.

### Appendix 4

The vapor chamber according to any one of appendixes 1 to 3, wherein
at least one of the inner pillars includes an interior pillar and
the entire interior pillar is arranged within the corresponding region when viewed from the second substrate side with respect to the first substrate.

According to such a configuration, it is possible to suppress the expansion of the portion corresponding to the placement region in the vapor chamber by the interior pillar entirely arranged in the corresponding region. Therefore, it is possible to increase the pressure resistance of the vapor chamber.

### Appendix 5

The vapor chamber according to any one of appendixes 1 to 4, wherein
the at least one inner pillar includes a peripheral pillar arranged around the corresponding region, and the peripheral pillar is arranged spanning inside and outside the corresponding region.

According to such a configuration, it is possible to suppress the expansion of the peripheral portion of the placement region due to heat acting on the placement region from the outside by the peripheral pillar. Therefore, it is possible to increase the pressure resistance of the vapor chamber.

### Appendix 6

The vapor chamber according to appendix 5, wherein
a plurality of the peripheral pillars are provided evenly spaced around the corresponding region and
of the plurality of outer pillars, a plurality of the outer pillars arranged around the at least one inner pillar are evenly spaced.

According to such a configuration, since the plurality of peripheral pillars are provided at equal intervals on the peripheral edge of the corresponding region, it is possible to effectively suppress the expansion of the portion corresponding to the placement region in the vapor chamber. Therefore, the flatness of the vapor chamber can be reduced.

Furthermore, since the multiple outer pillars arranged around the inner pillar are spaced at equal intervals, it is possible to prevent the outward diffusion of the working medium vaporized in the corresponding region from being obstructed by the multiple outer pillars.

### Appendix 7

The vapor chamber according to any one of appendixes 1 to 6, further includes:
a first capillary force structure body that is arranged on the inner surface of the first substrate within the accommodation chamber and that holds the working medium that is the liquid phase.

According to such a configuration, the liquid-phase working medium can be easily supplied to the corresponding region to which the heat from the heat-generating body is transmitted. Therefore, the efficiency of heat transfer from the heat-generating body to the working medium can be enhanced, and the efficiency of cooling of the heat-generating body can be enhanced.

### Appendix 8

The vapor chamber according to appendix 7, wherein
at least one inner pillar is bonded to the inner surface of the first substrate and is positioned to avoid the first capillary force structure body.

According to such a configuration, the inner pillar can be directly bonded to the inner surface of the first substrate. Therefore, the bonding strength between the inner pillar and the inner surface of the first substrate can be increased, and the pressure resistance strength of the vapor chamber can be further increased.

### Appendix 9

The vapor chamber according to appendix 7, wherein
at least one inner pillar is bonded to the inner surface of the first substrate through the first capillary force structure body.

According to such a configuration, since it is possible to suppress a decrease in the area of the first capillary force structure body due to the inner pillar, it is possible to suppress a decrease in the holding force and the transport force of the working medium in a liquid phase by the first capillary force structure body. Therefore, the working medium in a liquid phase can be efficiently transported to the corresponding region, whereby the efficiency of heat transfer from the heat-generating body to the working medium in a liquid phase can be enhanced.

### Appendix 10

The vapor chamber according to appendix 7, further includes:
a second capillary force structure body that is arranged on the inner surface of the second substrate within the accommodation chamber and that is configured to hold the working medium that is the liquid phase, wherein
one end of at least one inner pillar is bonded to the inner surface of the first substrate so as to avoid the first capillary force structure body and
the other end of the at least one inner pillar is bonded to the inner surface of the second substrate through the second capillary force structure body.

According to such a configuration, similarly to the above, one end of the inner pillar can be directly bonded to the inner surface of the first substrate. Therefore, the bonding strength between the inner pillar and the inner surface of the first substrate can be increased.

In addition, since a decrease in the area of the second capillary force structure body can be suppressed by the inner pillar, a decrease in the ability of the second capillary force structure body to retain and transport the liquid-phase working medium can be suppressed.

Therefore, the pressure-resistant strength of the vapor chamber can be further increased, and the liquid-phase working medium can be efficiently transported toward the corresponding region 526. Therefore, heat can be efficiently transferred from the heat-generating body, to the liquid-phase working medium.

### Appendix 11

The vapor chamber according to appendix 10, further includes:
a third capillary force structure body that is arranged on the outer surface of the inner pillar and that connects the first capillary force structure body and the second capillary force structure body to each other.

According to such a configuration, the liquid-phase working medium transported by the second capillary force structure body can be supplied to the first capillary force structure body via the third capillary force structure body, and further, the liquid-phase working medium can be easily supplied to the corresponding region. Therefore, the efficiency of heat transfer from the heat-generating body, to the liquid-phase working medium can be further increased, and the efficiency of cooling of the heat-generating body can be increased.

### Appendix 12

A cooling device includes:
the vapor chamber according to any one of appendix 1 to 11 and
   a heat-generating body bonded to the placement region.

According to such a configuration, it is possible to configure a cooling device capable of suppressing expansion of the vapor chamber while cooling the heat-generating body.

### Appendix 13

The electronic device includes: the cooling device according to appendix 12.

According to such a configuration, it is possible to achieve the same effect as that of the cooling device, and it is possible to configure an electronic device which can stably operate.

### Appendix 14

A wavelength conversion device includes:
the cooling device according to appendix 12
the heat-generating body is a fluorescent substance that converts the wavelength of incident light and emits fluorescent light and
the fluorescent substance is bonded to the placement region using a heat conductive bonding material.

According to such a configuration, since the fluorescent substance can be stably cooled, it is possible to configure a wavelength conversion device capable of stably emitting fluorescent light.

### Appendix 15

A projector includes
a light source;
the wavelength conversion device according to appendix 14, light incident from the light source acting as excitation light;
an image forming device that creates image light from light including the fluorescent light emitted by the fluorescent substance; and
a projection optical device that projects the image light.

According to such a configuration, it is possible to achieve the same effects as those of the wavelength conversion device described above, and it is possible to configure a projector that can operate stably.

What is claimed is:

1. A vapor chamber comprising:
a first substrate that has thermal conductivity;
a second substrate that faces the first substrate and that has thermal conductivity;
an accommodation chamber including an accommodation space configured by bonding together a peripheral section of the first substrate and a peripheral section of the second substrate;
a working medium that is accommodated in the accommodation chamber and that transitions between a gas phase and a liquid phase by heat; and
a plurality of pillars in the accommodation chamber between an inner surface of the first substrate and an inner surface of the second substrate, wherein
the first substrate includes
a placement region that is located on an outer surface of the first substrate and on which a heat-generating body is arranged and
a corresponding region that is located on an inner surface of the first substrate and that corresponds to the placement region,
the pillars include
at least one inner pillar arranged in the corresponding region and
a plurality of outer pillars arranged outside the corresponding region, and
the number of inner pillars per unit area in the corresponding region is larger than the number of pillars per unit area in the entire accommodation chamber.

2. The vapor chamber according to claim 1, wherein
a cross-sectional area along the inner surface of the first substrate in a portion of at least one inner pillar on the first substrate side is smaller than a cross-sectional area along the inner surface of the first substrate in a portion of each of the plurality of outer pillars on the first substrate side.

3. The vapor chamber according to claim 1, wherein
the thickness dimension of the first substrate at the placement region is smaller than the thickness dimension of the first substrate surrounding the placement region.

4. The vapor chamber according to claim 1, wherein
at least one of the inner pillars includes an interior pillar and
the entire interior pillar is arranged within the corresponding region when viewed from the second substrate side with respect to the first substrate.

5. The vapor chamber according to claim 1, wherein
the at least one inner pillar includes a peripheral pillar arranged around the corresponding region, and
the peripheral pillar is arranged spanning inside and outside the corresponding region.

6. The vapor chamber according to claim 5, wherein
a plurality of the peripheral pillars are provided evenly spaced around the corresponding region and
of the plurality of outer pillars, a plurality of the outer pillars arranged around the at least one inner pillar are evenly spaced.

7. The vapor chamber according to claim 1, further comprising:
a first capillary force structure body that is arranged on the inner surface of the first substrate within the accommodation chamber and that holds the working medium that is the liquid phase.

8. The vapor chamber according to claim 7, wherein
at least one inner pillar is bonded to the inner surface of the first substrate and is positioned to avoid the first capillary force structure body.

9. The vapor chamber according to claim 7, wherein
at least one inner pillar is bonded to the inner surface of the first substrate through the first capillary force structure body.

10. The vapor chamber according to claim 7, further comprising:
a second capillary force structure body that is arranged on the inner surface of the second substrate within the accommodation chamber and that is configured to hold the working medium that is the liquid phase, wherein
one end of at least one inner pillar is bonded to the inner surface of the first substrate so as to avoid the first capillary force structure body and
the other end of the at least one inner pillar is bonded to the inner surface of the second substrate through the second capillary force structure body.

11. The vapor chamber according to claim 10, further comprising:
a third capillary force structure body that is arranged on the outer surface of the inner pillar and that connects the first capillary force structure body and the second capillary force structure body to each other.

12. A cooling device comprising:
the vapor chamber according to claim 1; and
the heat-generating body bonded to the placement region.

13. A electronic device comprising:
the cooling device according to claim 12.

14. A wavelength conversion device comprising:
the cooling device according to claim 12, wherein
the heat-generating body is a fluorescent substance that converts the wavelength of incident light and emits fluorescent light and
the fluorescent substance is bonded to the placement region using a heat conductive bonding material.

15. A projector comprising:
a light source;
the wavelength conversion device, according to claim 14, light incident from the light source acting as excitation light;
an image forming device that creates image light from light including the fluorescent light emitted by the fluorescent substance; and
a projection optical device that projects the image light.
